(19) United States
(12) Patent Application Publication
(10) Pub. No.: US 2025/0199237 A1
(43) Pub. Date: Jun. 19, 2025

(54) OPTICAL WAVEGUIDE DEVICE AND SUBSTRATE WITH OPTICAL WAVEGUIDES

(71) Applicant: SHINKO ELECTRIC INDUSTRIES CO., LTD., Nagano (JP)

(72) Inventor: Yuji FURUTA, Nagano (JP)

(21) Appl. No.: 18/971,830

(22) Filed: Dec. 6, 2024

(30) Foreign Application Priority Data
Dec. 15, 2023 (JP) 2023-212166

(51) Int. Cl. G02B 6/12

(52) U.S. Cl. CPC G02B 6/12004; G02B 2006/12121

(57) ABSTRACT

An optical waveguide device includes a first and a second silicon photonics chip, an optical waveguide, and an encapsulation resin. The optical waveguide includes a core layer and a first and a second cladding layer. The core layer has a first and a second end portion optically coupled with a first and a second silicon waveguide, respectively, on surfaces of the first and the second silicon photonics chip. The first cladding layer covers a surface of the core layer between the first and the second end portion, and is thinner than the first and the second silicon photonics chip. The second cladding layer is stacked on the first cladding layer and covers the surfaces of the first and the second silicon photonics chip and the core layer. The encapsulation resin is stacked on the first cladding layer and covers the first and the second silicon photonics chip.

### CROSS-REFERENCE TO RELATED APPLICATION

This application is based upon and claims priority to Japanese Patent Application No. 2023-212166, filed on Dec. 15, 2023, the entire contents of which are incorporated herein by reference.

### FIELD

A certain aspect of the embodiments discussed herein is related to optical waveguide devices and substrates with optical waveguides.

### BACKGROUND

An optical waveguide device including a silicon photonics chip and optical waveguides is used to transmit and receive optical signals in a data center where various computers and data communications devices are installed. According to such an optical waveguide device, the silicon waveguides of the silicon photonics chip and the core layers of the optical waveguides are optically coupled. For example, a silicon photonics chip including silicon waveguides and optical waveguides including core layers are separately manufactured and are joined together to optically couple the silicon waveguides of the silicon photonics chip and the core layers of the optical waveguides (see Japanese Laid-open Patent Publication No. 2014-81586).

### SUMMARY

According to an aspect, an optical waveguide device includes a first and a second silicon photonics chip, an optical waveguide, and an encapsulation resin. The optical waveguide includes a core layer and a first and a second cladding layer. The core layer has a first and a second end portion optically coupled with a first and a second silicon waveguide, respectively, on surfaces of the first and the second silicon photonics chip. The first cladding layer covers a surface of the core layer between the first and the second end portion, and is thinner than the first and the second silicon photonics chip. The second cladding layer is stacked on the first cladding layer and covers the surfaces of the first and the second silicon photonics chip and the core layer. The encapsulation resin is stacked on the first cladding layer and covers the first and the second silicon photonics chip.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF DRAWINGS

FIG. 1 is a sectional view of an optical waveguide device according to a first embodiment;

FIGS. 2A through 2H are diagrams illustrating a process of manufacturing an optical waveguide device according to the first embodiment;

FIG. 3 is a sectional view of an optical waveguide device according to a variation of the first embodiment;

FIGS. 4A through 4C are diagrams illustrating a process of manufacturing an optical waveguide device according to the variation of the first embodiment;

FIG. 5 is a sectional view of an optical waveguide device according to a second embodiment; and

FIG. 6 is a sectional view of a substrate with optical waveguides according to a third embodiment.

### DESCRIPTION OF EMBODIMENTS

According to an embodiment, an optical waveguide device with high positional accuracy between the silicon waveguides of a silicon photonics chip and the core layers of optical waveguides is provided.

Embodiments of the present invention are described below with reference to the accompanying drawings. In the following, the same elements or components are referred to using the same reference numerals, and duplicate description thereof may be omitted.

### [a] First Embodiment

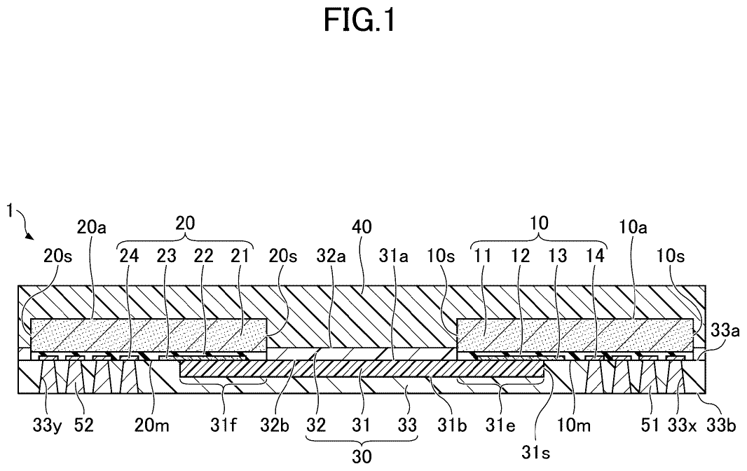

FIG. 1 is a sectional view of an optical waveguide device according to a first embodiment. Referring to FIG. 1, an optical waveguide device 1 includes a silicon photonics chip 10, a silicon photonics chip 20, optical waveguides 30, and an encapsulation resin 40.

The silicon photonics chip 10 includes a silicon substrate 11, an insulating layer 12, silicon waveguides 13, and electrodes 14. The silicon substrate 11 has a surface covered with the insulating layer 12. The silicon waveguides 13 and the electrodes 14 are provided in the silicon photonics chip 10 on its principal surface (second surface) 10m side. For example, the silicon waveguides 13 and the electrodes 14 may be provided in the principal surface 10m of the silicon photonics chip 10 as illustrated in FIG. 1.

The silicon photonics chip 20 includes a silicon substrate 21, an insulating layer 22, silicon waveguides 23, and electrodes 24. The silicon substrate 21 has a surface covered with the insulating layer 22. The silicon waveguides 23 and the electrodes 24 are provided in the silicon photonics chip 20 on its principal surface (second surface) 20m side. For example, the silicon waveguides 23 and the electrodes 24 may be provided in the principal surface 20m of the silicon photonics chip 20 as illustrated in FIG. 1.

The thickness of the silicon substrate 11 is, for example, approximately 100 μm to approximately 800 μm. The silicon waveguides 13 are micro optical waveguides, and are provided in the insulating layer 12 in the example of FIG. 1. The insulating layer 12 may be formed of, for example, SiO₂, Siox or the like. The thickness of the insulating layer 12 may be, for example, approximately 2 μm to approximately 6 μm.

FIG. 1 illustrates a non-limiting example. The silicon waveguides 13 may be buried in the silicon substrate 11. In this case, the surfaces of the silicon waveguides 13 facing core layers 31 may be either exposed or not exposed from the silicon substrate 11.

The electrodes 14 are electrically connected to an integrated circuit provided in the silicon photonics chip 10. The electrodes 14 may be formed of, for example, metal such as copper or aluminum. The electrodes 14, which are provided in the insulating layer 12 according to the example of FIG. 1, may be buried in the silicon substrate 11. In this case, the electrodes 14 are partly exposed from the silicon substrate 11.

The silicon photonics chip 10 and the silicon photonics chip 20 are spaced apart from each other such that the silicon waveguides 13 and the silicon waveguides 23 face each other. The silicon photonics chip 10 and the silicon photonics chip 20 may have the same structure. The structure, material and thickness of the constituent elements of the silicon photonics chip 20 may be the same as those of the constituent elements of the silicon photonics chip 10.

The optical waveguides 30 face the principal surface 10m of the silicon photonics chip 10 and the principal surface 20m of the silicon photonics chip 20. The optical waveguides 30 includes their respective core layers 31, a first cladding layer 32, and a second cladding layer 33.

Each core layer 31 is partly in contact with the principal surface 10m of the silicon photonics chip 10 and the principal surface 20m of the silicon photonics chip 20.

The core layers 31 have respective first end portions 31e placed on the principal surface 10m of the silicon photonics chip 10 to be optically coupled with the silicon waveguides 13 and have respective second end portions 31f placed on the principal surface 20m of the silicon photonics chip 20 to be optically coupled with the silicon waveguides 23. This enables the silicon photonics chip 10 and the silicon photonics chip 20 to transmit and receive optical signals via the core layers 31. The core layers 31 and the silicon waveguides 13 and 23 may be optically coupled in any manner. For example, the core layers 31 may be adiabatically coupled or directly coupled with the silicon waveguides 13 and 23.

The width of each core layer 31 may be, for example, approximately 6 μm to approximately 10 μm. The thickness of each core layer 31 may be, for example, approximately 6 μm to approximately 10 μm. The refractive index of each core layer 31 is higher than the refractive index of the first cladding layer 32 and the second cladding layer 33, and may be, for example, approximately 1.6. Examples of the material of the core layers 31 include photosensitive resins such as polyimide resin, acrylic resin, epoxy resin, polyolefin resin, and polynorbornene resin. The core layers 31 may be arranged side by side.

The first cladding layer 32 covers a lower part (on the principal surface 10m side) of a side surface 10s of the silicon photonics chip 10, a lower part (on the principal surface 20m side) of a side surface 20s of the silicon photonics chip 20, and a first (upper) surface 31a of each core layer 31 extending between the first end portion 31e and the second end portion 31f of the core layer 31. A second (lower) surface 32b of the first cladding layer 32 may be flush with, for example, the principal surface 10m of the silicon photonics chip 10 and the principal surface 20m of the silicon photonics chip 20. The thickness of the first cladding layer 32 may be, for example, approximately 10 μm to approximately 30 μm. The refractive index of the first cladding layer 32 may be, for example, approximately 1.5. The first cladding layer 32 may be formed of, for example, a material suitably selected from those illustrated as examples of the material of the core layers 31.

The second cladding layer 33 is stacked on the first cladding layer 32 on the core layer 31 side and covers the principal surface 10m of the silicon photonics chip 10, the principal surface 20m of the silicon photonics chip 20, and second (lower) surfaces 31b and side surfaces 31s of the core layers 31. The thickness of the second cladding layer 33 may be, for example, approximately 10 μm to approximately 30 μm. The refractive index of the second cladding layer 33 may be, for example, approximately 1.5. The second cladding layer 33 may be formed of, for example, a material suitably selected from those illustrated as examples of the material of the core layers 31. The material of the second cladding layer 33 may be the same as the material of the first cladding layer 32.

According to the example of FIG. 1, through vias 51 pierces through the second cladding layer 33 to have respective first end faces connected to the electrodes 14 and respective second end faces exposed from the second cladding layer 33. The through vias 51 are placed in associated via holes 33x that pierce through the second cladding layer 33 to expose the lower surfaces of the electrodes 14, and are directly connected to the electrodes 14. Furthermore, through vias 52 pierces through the second cladding layer 33 to have respective first end faces connected to the electrodes 24 and respective second end faces exposed from the second cladding layer 33. The through vias 52 are placed in associated via holes 33y that pierce through the second cladding layer 33 to expose the lower surfaces of the electrodes 24, and are directly connected to the electrodes 24. The through vias 51 and 52 may have, for example, a truncated cone shape narrowing toward the electrodes 14 and 24. The lower surfaces of the through vias 51 and 52 are exposed from a second (lower) surface 33b of the second cladding layer 33. The lower surfaces of the through vias 51 and 52 may be flush with the second surface 33b of the second cladding layer 33, for example. The through vias 51 and 52 may be formed of, for example, copper.

Other electrodes may be provided on the opposite side from the electrodes 14 and 24 in the thickness direction of the silicon substrates 11 and 21, and through vias that connected the other electrodes may be provided. These through vias pierce through the encapsulation resin 40 to be exposed from the upper surface of the encapsulation resin 40 for external connections.

The encapsulation resin 40 is stacked on the first cladding layer 32 on the opposite side from the second cladding layer 33 to cover the silicon photonics chip 10 and the silicon photonics chip 20. The encapsulation resin 40 may cover, for example, the entirety of part of the side surfaces 10s and 20s of the silicon photonics chips 10 and 20 which part is not covered by the first cladding layer 32 and the entirety of an upper surface (first surface) 10a of the silicon photonics chip 10 and an upper surface (first surface) 20a of the silicon photonics chip 20.

For example, so-called mold resin, which is epoxy resin containing filler, may be used as the encapsulation resin 40. The encapsulation resin 40 is higher in rigidity than each constituent resin of the optical waveguides 30. For example, the Young's modulus of the optical waveguides 30 is 1 GPa to 10 GPa, while the Young's modulus of the encapsulation resin 40 is 1 GPa to 30 GPa.

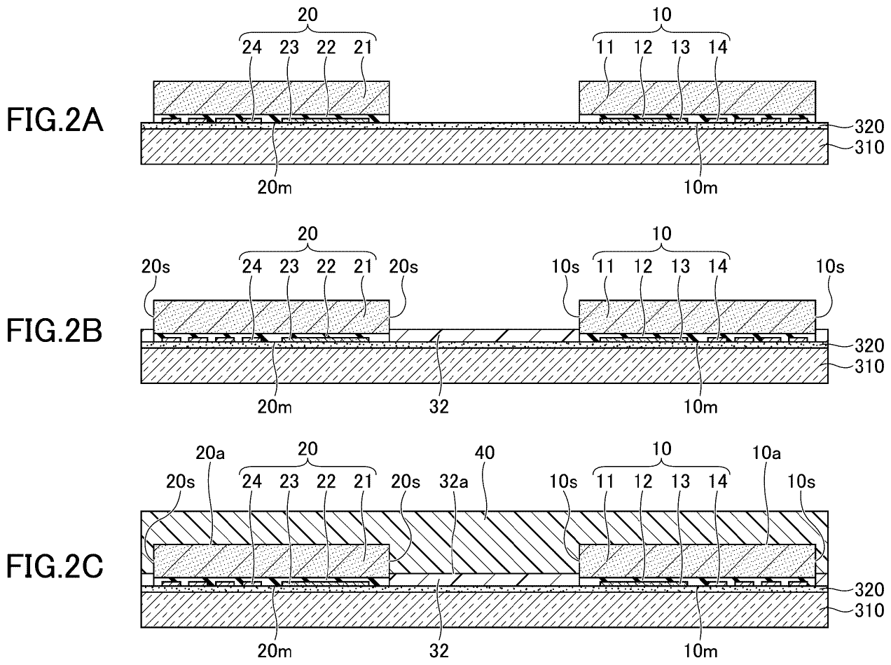

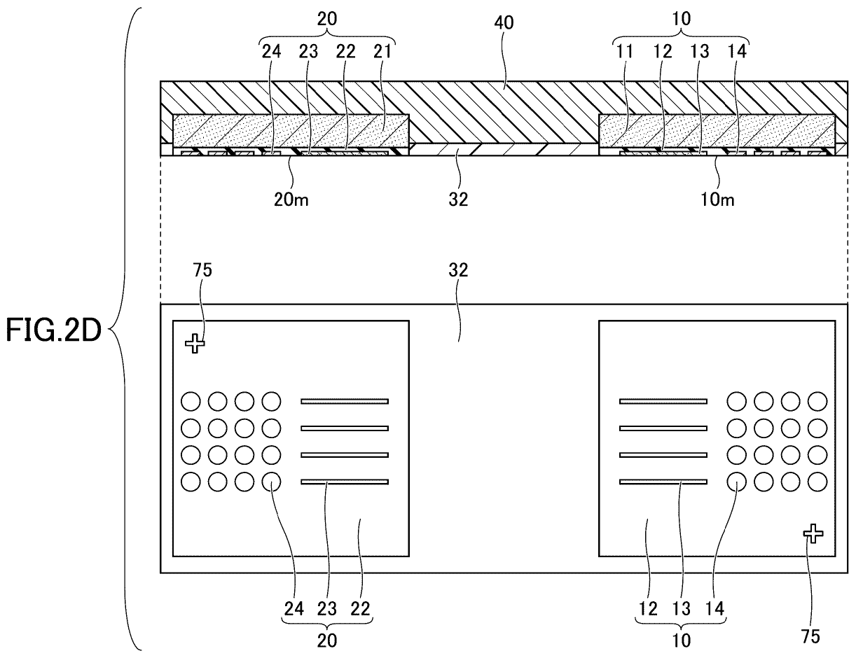

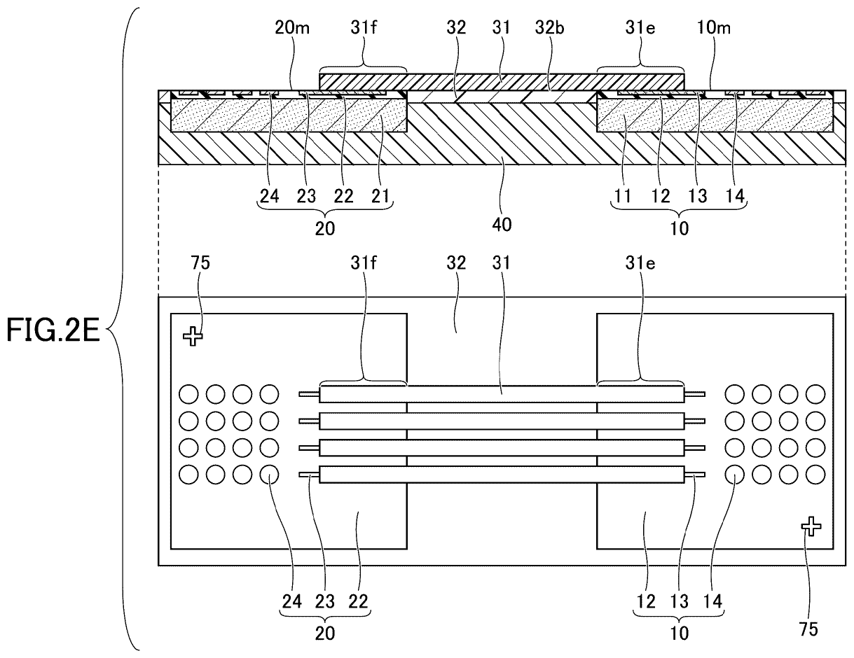

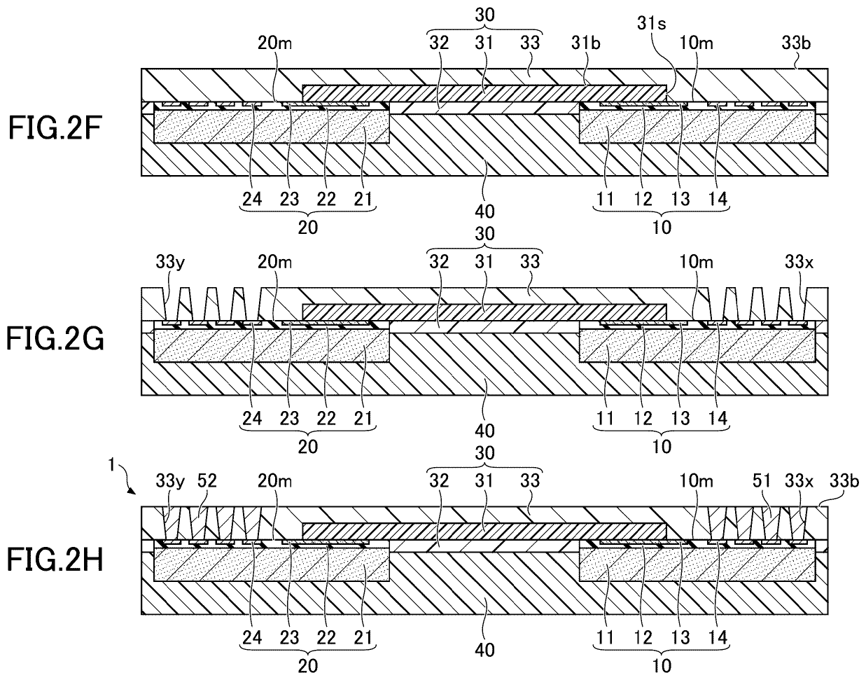

FIGS. 2A through 2H are diagrams illustrating a process of manufacturing an optical waveguide device according to the first embodiment. First, in the process illustrated in FIG. 2A, a support 310 is prepared, and a bonding layer 320 is formed on a surface of the support 310. Alternatively, the support 310 having the bonding layer 320 preformed on a surface of the support 310 may be purchased and prepared. Then, the silicon photonics chips 10 and 20 are placed on the support 310 via the bonding layer 320 with the principal surfaces 10m and 20m facing the support 310. The silicon photonics chip 10 and the silicon photonics chip 20 are spaced apart from each other with the silicon waveguides 13 and the silicon waveguides 23 facing each other. It is preferable that the support 310 have high flatness and be composed of a material that transmits ultraviolet radiation. For example, a sheet of glass, a sheet of acrylic resin or the like may be used as the support 310. The bonding layer 320 may be composed of a material that is removed by exposure to ultraviolet radiation through the support 310.

Next, in the process illustrated in FIG. 2B, the first cladding layer 32 covering a lower part (on the principal surface 10m side) of the side surface 10s of the silicon photonics chip 10 and a lower part (on the principal surface 20m side) of the side surface 20s of the silicon photonics chip 20 is formed on the support 310.

The first cladding layer 32 may be formed by, for example, applying photosensitive resin liquid or paste on the bonding layer 320 and thereafter curing the applied photosensitive resin liquid or paste by exposure to ultraviolet radiation or by heating. The material, etc., of the first cladding layer 32 are as described above.

Next, in the process illustrated in FIG. 2C, the encapsulation resin 40 is formed on the silicon photonics chip 10, the silicon photonics chip 20, and the first cladding layer 32. For example, so-called mold resin, which is epoxy resin containing filler, may be used as the encapsulation resin 40. The encapsulation resin 40 may be formed by, for example, transfer molding, compression molding or the like. The encapsulation resin 40 may be formed to cover the upper surfaces 10a and 20a and part of the side surfaces 10s and 20s of the silicon photonics chips 10 and 20, which are exposed from the first cladding layer 32, and a first (upper) surface 32a of the first cladding layer 32, for example.

Next, in the process illustrated in FIG. 2D, the support 310 and the bonding layer 320 are removed from the structure illustrated in FIG. 2C. In the subsequent processes, the encapsulation resin 40 serves as a support. The support 310 and the bonding layer 320 may be removed by, for example, reducing the bonding strength of the bonding layer 320 by exposing the bonding layer 320 to ultraviolet radiation through the support 310. In FIG. 2D, the drawing on the lower side is a view of the structure depicted on the upper side as seen from the principal surface side of the silicon photonics chips 10 and 20. As illustrated in the lower-side drawing, alignment marks 75 are provided in the principal surface 10m of the silicon photonics chip 10 and the principal surface 20m of the silicon photonics chip 20.

The alignment marks 75 may be formed of the same material as the silicon waveguides 13 and 23 in the same layer as the silicon waveguides 13 and 23. The alignment marks 75 may be formed in the same process as the silicon waveguides 13 and 23 by a semiconductor process. Therefore, the position accuracy of the silicon waveguides 13 and 23 relative to the alignment marks 75 is extremely good. The shape, number, and formation positions of the alignment marks 75 are not limited to those of the example illustrated in FIG. 2D.

Next, in the process illustrated in FIG. 2E, the core layers 31 are directly formed on the principal surface 10m of the silicon photonics chip 10, the principal surface 20m of the silicon photonics chip 20, and the first cladding layer 32 by photolithography. Specifically, for example, the entirety of the principal surface 10m of the silicon photonics chip 10, the principal surface 20m of the silicon photonics chip 20, and the second surface 32b of the first cladding layer 32 are laminated with a film of photosensitive resin for forming the core layers 31. Then, after the photosensitive resin is exposed to light and developed through a photomask, the photosensitive resin is cured to form the core layers 31. The core layers 31 may alternatively be formed using photosensitive resin liquid or paste. The material, etc., of the core layers 31 are as described above.

The core layers 31 have their respective first end portions 31e placed on the principal surface 10m of the silicon photonics chip 10 to be optically coupled with the silicon waveguides 13 and have their respective second end portions 31f placed on the principal surface 20m of the silicon photonics chip 20 to be optically coupled with the silicon waveguides 23. Referring to FIG. 2E, the core layers 31 lie (extend) over the gap between the silicon photonics chip 10 and the silicon photonics chip 20, where the gap is filled with the first cladding layer 32 and the encapsulation resin 40. In this process, it is possible to align the silicon waveguides 13 and 23 and the core layers 31 with high accuracy using the alignment marks 75. For example, it is possible to align the core layers 31 with the silicon waveguides 13 and 23 with the accuracy of ±1 μm or less. The alignment marks 75 are recognizable through the photosensitive resin to become the core layers 31.

In FIG. 2E, the drawing on the lower side is a view of the structure depicted on the upper side as seen from the principal surface side of the silicon photonics chips 10 and 20. As illustrated in the lower-side drawing, the four core layers 31 are arranged side by side according to this embodiment. The number of core layers is not limited to the example illustrated in FIG. 2E. Furthermore, the core layers 31 may have a shape other than the rectilinear shape.

Next, in the process illustrated in FIG. 2F, the second cladding layer 33 covering the core layers 31 is formed on the principal surface 10m of the silicon photonics chip 10, the principal surface 20m of the silicon photonics chip 20, and the first cladding layer 32. The second cladding layer 33 may be formed, using, for example, photosensitive resin in film, liquid or paste form the same as the core layers 31. The material, etc., of the second cladding layer 33 are as described above. The second cladding layer 33 is stacked on the first cladding layer 32 to cover the principal surface 10m of the silicon photonics chip 10, the principal surface 20m of the silicon photonics chip 20, and the second surfaces 31b and the side surfaces 31s of the core layers 31.

Next, in the processes illustrated in FIGS. 2G and 2H, the through vias 51 piercing through the second cladding layer 33 to have their respective first end faces connected to the electrodes 14 and their respective second end faces exposed from the second cladding layer 33 are formed. Furthermore, the through vias 52 piercing through the second cladding layer 33 to have their respective first end faces connected to the electrodes 24 and their respective second end faces exposed from the second cladding layer 33, are formed.

Specifically, first, as illustrated in FIG. 2G, the via holes 33x piercing through the second cladding layer 33 to expose the upper surfaces of the electrodes 14 and the via holes 33y piercing through the second cladding layer 33 to expose the upper surfaces of the electrodes 24 are formed. The via holes 33x and 33y may be formed by, for example, emitting laser light from the second surface 33b side of the second cladding layer 33. For example, a CO₂ laser may be used to emit the laser light. It is possible to form the via holes 33x and 33y at desired positions with accuracy using the alignment marks 75 also in forming the via holes 33x and 33y.

Next, as illustrated in FIG. 2H, the through vias 51 that fill in the via holes 33x and the through vias 52 that fill in the via holes 33y are formed. The through vias 51 and 52 may be formed using, for example, a semi-additive process. After formation of the through vias 51 and 52, the second surface 33b of the second cladding layer 33 may be polished to be flattened on an as-needed basis. The upper surfaces (second end faces) of the through vias 51 and 52 may be flush with the second surface 33b of the second cladding layer 33, for example. Through the above-described processes, the optical waveguide device 1 is completed. The structure illustrated in FIG. 2F may be a finished product of the optical waveguide device 1. In this case, a person who obtains the structure illustrated in FIG. 2F through purchase may carry out the processes illustrated in FIGS. 2G and 2H when necessary.

Thus, according to the optical waveguide device 1, instead of separately manufacturing and joining the silicon photonics chips 10 and 20 including the silicon waveguides 13 and 23, respectively, and the optical waveguides 30 including the core layers 31, the core layers 31 are directly formed on the silicon waveguides 13 and 23 with the encapsulation resin 40 serving as a support. Therefore, it is possible to manufacture the optical waveguide device 1 with high positional accuracy between the silicon waveguides 13 of the silicon photonics chip 10, the silicon waveguides 23 of the silicon photonics chip 20, and the core layers 31 of the optical waveguides 30.

In the case of using the alignment marks 75 formed in the same layer as the silicon waveguides 13 and 23 using the same material as the silicon waveguides 13 and 23, it is possible to manufacture the optical waveguide device 1 with particularly high positional accuracy between the silicon waveguides 13 and 23 and the core layers 31.

Furthermore, when the optical waveguide device 1 includes the through vias 51 and 52 exposed from the second cladding layer 33, the optical waveguide device 1 may be handled in the same manner as in the case of mounting a normal semiconductor chip on a wiring substrate. Therefore, the optical waveguide device 1 can be easily mounted on a wiring substrate or the like and be electrically connected to electrodes of the wiring substrate.

Next, a variation of the first embodiment is described. The variation of the first embodiment illustrates an optical waveguide device whose through vias are different in shape from those of the optical waveguide device 1 of the first embodiment. In the following description of the variation, a description of the same elements or components as those of the above-described embodiment may be omitted.

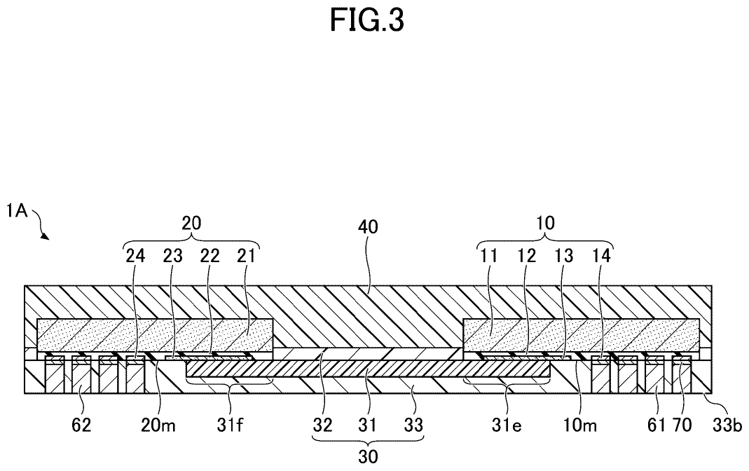

FIG. 3 is a sectional view of an optical waveguide device according to the variation of the first embodiment. Referring to FIG. 3, an optical waveguide device 1A is different from the optical waveguide device 1 in that the through vias 51 and 52 are replaced with through vias 61 and 62.

According to the example of FIG. 3, the through vias 61 pierce through the second cladding layer 33 to have respective first end faces connected to the electrodes 14 and respective second end faces exposed from the second cladding layer 33. The through vias 61 are joined to the electrodes 14 via an electrically conductive joining material 70. Furthermore, the through vias 62 pierce through the second cladding layer 33 to have respective first end faces connected to the electrodes 24 and respective second end faces exposed from the second cladding layer 33. The through vias 62 are joined to the electrodes 24 via the conductive joining material 70. Examples of the conductive joining material 70 include solder.

The through vias 61 and 62 may have, for example, a pillar shape (such as a cylindrical shape, an elliptical cylindrical shape, or a rectangular prism shape). For example, copper posts may be used as the through vias 61 and 62. The second end faces (lower surfaces) of the through vias 61 and 62 are exposed from the second surface 33b of the second cladding layer 33. The second end faces of the through vias 61 and 62 may be flush with the second surface 33b of the second cladding layer 33, for example.

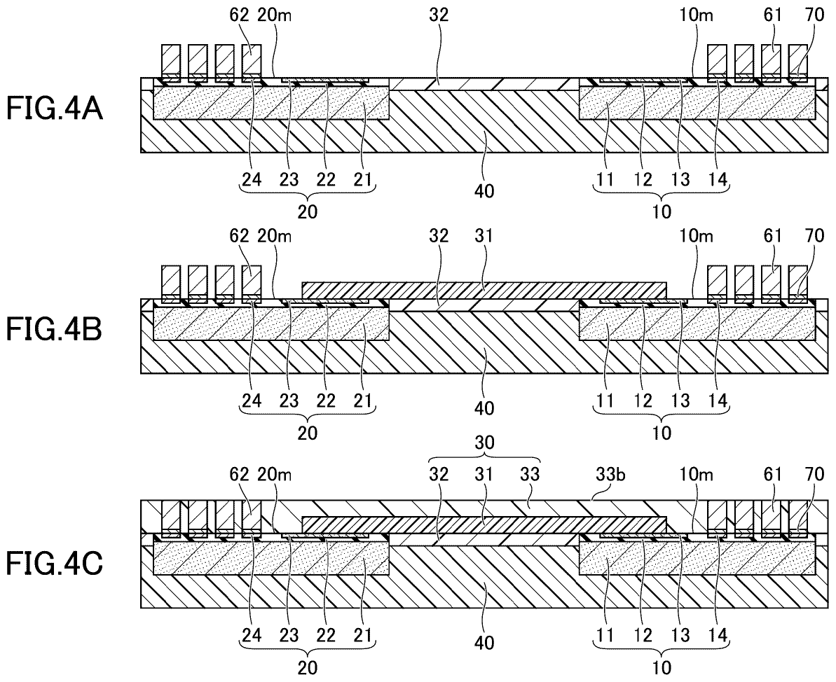

FIGS. 4A through 4C are diagrams illustrating a process of manufacturing an optical waveguide device according to the variation of the first embodiment. First, the processes of FIGS. 2A through 2D of the first embodiment are carried out. Thereafter, in the process illustrated in FIG. 4A, copper posts or the like to serve as the through vias 61 are placed over the electrodes 14 via the conductive joining material 70. Furthermore, copper posts or the like to serve as the through vias 62 are placed over the electrodes 24 via the conductive joining material 70. Then, the conductive joining material 70 is melted by heating and thereafter solidified to fix the copper posts or the like onto the electrodes 14 and 24.

Next, in the process illustrated in FIG. 4B, the same as in the process of FIG. 2E, the core layers 31 are formed. In the process illustrated in FIG. 4C, the same as in the process of FIG. 2F, the second cladding layer 33 is formed. The second cladding layer 33 is formed to cover the side surfaces of the through vias 61 and 62 with their respective second end faces (upper surfaces in FIG. 4C) exposed from the second surface 33b of the second cladding layer 33. The second surface 33b of the second cladding layer 33 may be polished to be flattened on an as-needed basis. The upper surfaces (second end faces) of the through vias 61 and 62 may be flush with the second surface 33b of the second cladding layer 33, for example. Through the above-described processes, the optical waveguide device 1A is completed.

The manufacturing process of the optical waveguide device 1A does not include the process of forming individual via holes with a laser. Therefore, the optical waveguide device 1A can be manufactured in a simpler process.

### [b] Second Embodiment

A second embodiment illustrates an optical waveguide device with a semiconductor laser device. In the following description of the second embodiment, a description of the same elements or components as those of the above-described embodiment may be omitted.

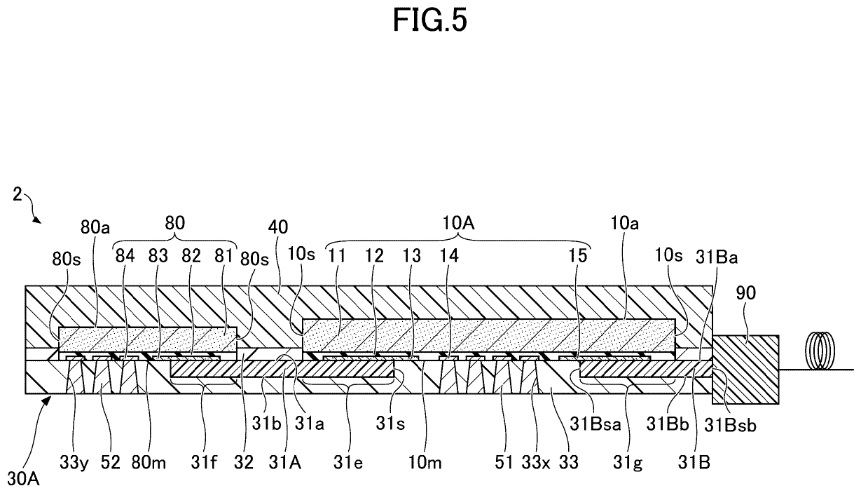

FIG. 5 is a sectional view of an optical waveguide device according to the second embodiment. Referring to FIG. 5, an optical waveguide device 2 includes a silicon photonics chip 10A, a semiconductor laser device 80, optical waveguides 30A, the encapsulation resin 40, and an optical fiber 90.

The silicon photonics chip 10A includes the silicon substrate 11, the insulating layer 12, the silicon waveguides 13, silicon waveguides 15, and the electrodes 14. The silicon substrate 11 has a surface covered with the insulating layer 12. The silicon waveguides 13 and 15 and the electrodes 14 are provided in the silicon photonics chip 10A on its principal surface 10m side. For example, the silicon waveguides 13 and 15 and the electrodes 14 may be provided in the principal surface 10m of the silicon photonics chip 10A. The silicon waveguides 15 may be placed on the opposite side of the electrodes 14 from the silicon waveguides 13, for example. The material, thickness, etc., of the silicon waveguides 15 may be the same as those of the silicon waveguides 13.

The semiconductor laser device 80 includes a silicon substrate 81, an insulating layer 82, silicon waveguides 83, and electrodes 84. The silicon substrate 81 has a surface covered with the insulating layer 82. The silicon waveguides 83 and the electrodes 84 are provided in the semiconductor laser device 80 on its principal surface (second surface) 80m side. For example, the silicon waveguides 83 and the electrodes 84 may be provided in the principal surface 80m of the semiconductor laser device 80. The silicon photonics chip 10A and the semiconductor laser device 80 are spaced apart from each other such that the silicon waveguides 13 and the silicon waveguides 83 face each other.

The material, thickness, etc., of the silicon substrate 81, the insulating layer 82, the silicon waveguides 83, and the electrodes 84 may be the same as those of the silicon substrate 11, the insulating layer 12, the silicon waveguides 13, and the electrodes 14, respectively. The silicon substrate 81 may be different in thickness from the silicon substrate 11.

The optical waveguides 30A are stacked on the principal surface 10m of the silicon photonics chip 10A and the principal surface 80m of the semiconductor laser device 80. The optical waveguides 30A include respective first core layers 31A, respective second core layers 31B, the first cladding layer 32, and the second cladding layer 33.

Each first core layer 31A is partly in contact with the principal surface 10m of the silicon photonics chip 10A and the principal surface 80m of the semiconductor laser device 80. The first core layers 31A have their respective first end portions 31e placed on the principal surface 10m of the silicon photonics chip 10A to be optically coupled with the silicon waveguides 13 and have their respective second end portions 31f placed on the principal surface 80m of the semiconductor laser device 80 to be optically coupled with the silicon waveguides 83.

The second core layers 31B have respective end portions 31gplaced on the principal surface 10m of the silicon photonics chip 10A to be optically coupled with the silicon waveguides 15. This enables the silicon photonics chip 10A to receive optical signals from the semiconductor laser device 80 through the first core layers 31A and to transmit optical signals through the second core layers 31B.

The first core layers 31A and the silicon waveguides 13 and 83 may be optically coupled in any manner. Furthermore, the second core layers 31B and the silicon waveguides 15 may be optically coupled in any manner. For example, the first core layers 31A and the silicon waveguides 13 and 83 may be adiabatically coupled or directly coupled, and the second core layers 31B and the silicon waveguides 15 may be adiabatically coupled or directly coupled.

The first cladding layer 32 covers a lower part (on the principal surface 10m side) of the side surface 10s of the silicon photonics chip 10A and a lower part (on the principal surface 80m side) of a side surface 80s of the semiconductor laser device 80. Furthermore, the first cladding layer 32 covers the first (upper) surface 31a of each first core layer 31A extending between the first end portion 31e and the second end portion 31f of the first core layer 31A and covers a first (upper) surface 31Ba of each second core layer 31B except for the end portion 31g.

The second cladding layer 33 is stacked on the first cladding layer 32 to cover the principal surface 10m of the silicon photonics chip 10A, the principal surface 80m of the semiconductor laser device 80, the second (lower) surfaces 31b and the side surfaces 31s of the first core layers 31A, and second (lower) surfaces 31Bb and first side surfaces 31Bsa of the second core layers 31B. The second core layers 31B have respective second side surfaces 31Bsb exposed from the first cladding layer 32 and the second cladding layer 33 to be optically coupled with the optical fiber 90 placed next to (adjoining) the optical waveguides 30A and the encapsulation resin 40. The optical fiber 90 is, for example, a fiber array including as many optical fibers as or more optical fibers than the second core layers 31B. The optical fibers and the second core layers 31B are optically coupled in one-to-one correspondence. For example, butt coupling may be used to join the second side surfaces 31Bsb of the second core layers 31B and the optical fiber 90 together. For example, the optical fiber 90 and the second core layers 31B may be aligned and joined together using optical adhesive.

The encapsulation resin 40 is stacked on the first cladding layer 32 on the opposite side from the second cladding layer 33 to cover the silicon photonics chip 10A and the semiconductor laser device 80. The encapsulation resin 40 may cover, for example, the entirety of part of the side surfaces 10s and 80s of the silicon photonics chip 10A and the semiconductor laser device 80 which part is not covered by the first cladding layer 32 and the entirety of the upper surface 10a of the silicon photonics chip 10A and an upper surface (first surface) 80a of the semiconductor laser device 80.

The optical waveguide device 2 may be manufactured in the following process in substantially the same manner as the optical waveguide device 1. First, the silicon photonics chip 10A, which includes the silicon waveguides 13, the silicon waveguides 15, and the electrodes 14 on its principal surface 10m side, and the semiconductor laser device 80, which includes the silicon waveguides 83 and the electrodes 84 on its principal surface 80m side, are placed on a support with their respective principal surfaces 10m and 80m facing the support.

Next, the first cladding layer 32 covering a lower part (on the principal surface 10m side) of the side surface 10s of the silicon photonics chip 10A and a lower part (on the principal surface 80m side) of the side surface 80s of the semiconductor laser device 80 is formed on the support. Next, the encapsulation resin 40 is formed on the silicon photonics chip 10A, the semiconductor laser device 80, and the first cladding layer 32. Then, the support is removed.

Next, the first core layers 31A are directly formed on the principal surface 10m of the silicon photonics chip 10A, the principal surface 80m of the semiconductor laser device 80, and the first cladding layer 32, and the second core layers 31B are directly formed on the principal surface 10m of the silicon photonics chip 10A and the first cladding layer 32. The first core layers 31A are formed such that their respective first end portions 31e are placed on the principal surface 10m of the silicon photonics chip 10A to be optically coupled with the silicon waveguides 13 and their respective second end portions 31f are placed on the principal surface 80m of the semiconductor laser device 80 to be optically coupled with the silicon waveguides 83. The first core layers 31A lie (extend) over the gap between the silicon photonics chip 10A and the semiconductor laser device 80, where the gap is filled with the first cladding layer 32 and the encapsulation resin 40. The second core layers 31B are formed such that their respective end portions 31g are placed on the principal surface 10m of the silicon photonics chip 10A to be optically coupled with the silicon waveguides 15.

Next, the second cladding layer 33 covering the first core layers 31A and the second core layers 31B is formed on the principal surface 10m of the silicon photonics chip 10A, the principal surface 80m of the semiconductor laser device 80, and the first cladding layer 32. Then, the optical fiber 90 is optically coupled with the other end portions of the second core layers 31B.

Thus, according to the optical waveguide device 2, in the same manner as the optical waveguide device 1, the first core layers 31A are directly formed on the silicon waveguides 13 and 83 and the second core layers 31B are directly formed on the silicon waveguides 15 with the encapsulation resin 40 serving as a support. Therefore, it is possible to manufacture the optical waveguide device 2 with high positional accuracy between the silicon waveguides 13, the silicon waveguides 83, and the first core layers 31A and high positional accuracy between the silicon waveguides 15 and the second core layers 31B. The optical waveguide device 2 may be used as, for example, an optical transceiver that converts an electrical signal into an optical signal and transmits the optical signal.

### [c] Third Embodiment

A third embodiment illustrates a substrate with optical waveguides on which an optical waveguide device according to the second embodiment is mounted. In the following description of the third embodiment, a description of the same elements or components as those of the above-described embodiments may be omitted.

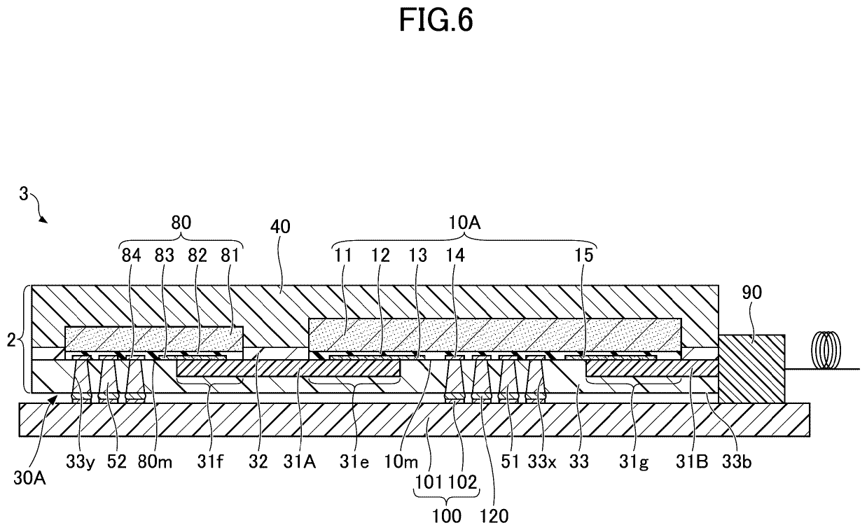

FIG. 6 is a sectional view of a substrate with optical waveguides according to the third embodiment. Referring to FIG. 6, a substrate with optical waveguides 3 includes the optical waveguide device 2 and a wiring substrate 100 including connection terminals 102 on one side.

The wiring substrate 100 includes an insulating layer 101 on which the connection terminals 102 are placed. The wiring substrate 100 may be either a rigid substrate with high rigidity or a flexible substrate with low rigidity. The wiring substrate 100 is, for example, a build-up substrate. The wiring substrate 100 may be a silicon substrate or a ceramic substrate.

The optical waveguide device 2 is mounted on the wiring substrate 100 on its one side with the second cladding layer 33 of the optical waveguides 30A facing the connection terminals 102. The second end faces of the through vias 51 and 52 of the optical waveguide device 2, which are on the opposite side from the electrodes 14 and 84, are jointed to the connection terminals 102 of the wiring substrate 100 via an electrically conductive joining material 120. Examples of the conductive joining material 120 include solder.

An underfill resin that covers the conductive joining material 120 may be placed between the opposing surfaces of the wiring substrate 100 and the optical waveguides 30A.

According to the optical waveguide device 2, the lower surfaces (second end faces) of the through vias 51 and 52 are exposed from the second surface (lower surface) 33b of the second cladding layer 33. Therefore, the substrate with optical waveguides 3 can be easily manufactured by connecting the through vias 51 and 52 and the connection terminals 102 of the wiring substrate 100 by the conductive joining material 120. The optical waveguide device 1 or 1A may be mounted on the wiring substrate 100 in place of the optical waveguide device 2.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

Various aspects of the subject-matter described herein may be set out non-exhaustively in the following numbered clauses:

1. A method of manufacturing an optical waveguide device, comprising:
placing a first silicon photonics chip and a second silicon photonics chip on a support with a principal surface of the first silicon photonics chip and a principal surface of the second silicon photonics chip facing the support, the first silicon photonics chip including a first silicon waveguide and a first electrode on the principal surface side, the second silicon photonics chip including a second silicon waveguide and a second electrode on the principal surface side;
forming a first cladding layer on the support such that the first cladding layer covers a side surface of the first silicon photonics chip on the principal surface side and a side surface of the second silicon photonics chip on the principal surface side;
forming an encapsulation resin on the first silicon photonics chip, the second silicon photonics chip, and the first cladding layer;
removing the support;
forming a core layer directly on the principal surface of the first silicon photonics chip, the principal surface of the second silicon photonics chip, and the first cladding layer such that a first end portion of the core layer is placed on the principal surface of the first silicon photonics chip to be optically coupled with the first silicon waveguide and a second end portion of the core layer is placed on the principal surface of the second silicon photonics chip to be optically coupled with the second silicon waveguide; and
forming a second cladding layer on the principal surface of the first silicon photonics chip, the principal surface of the second silicon photonics chip, and the first cladding layer such that the second cladding layer covers the core layer.

2. A method of manufacturing an optical waveguide device, comprising:
placing a silicon photonics chip and a semiconductor laser device on a support with a principal surface of the silicon photonics chip and a principal surface of the semiconductor laser device facing the support, the silicon photonics chip including a first silicon waveguide, a second silicon waveguide, and a first electrode on the principal surface side, the semiconductor laser device including a third silicon waveguide and a second electrode on the principal surface side;
forming a first cladding layer on the support such that the first cladding layer covers a side surface of the silicon photonics chip on the principal surface side and a side surface of the semiconductor laser device on the principal surface side;
forming an encapsulation resin on the silicon photonics chip, the semiconductor laser device, and the first cladding layer;
removing the support;
forming a first core layer directly on the principal surface of the silicon photonics chip, the principal surface of the semiconductor laser device, and the first cladding layer such that a first end portion of the first core layer is placed on the principal surface of the silicon photonics chip to be optically coupled with the first silicon waveguide and a second end portion of the first core layer is placed on the principal surface of the semiconductor laser device to be optically coupled with the third silicon waveguide, and forming a second core layer directly on the principal surface of the silicon photonics chip and the first cladding layer such that a first end portion of the second core layer is placed on the principal surface of the silicon photonics chip to be optically coupled with the second silicon waveguide;
forming a second cladding layer on the principal surface of the silicon photonics chip, the principal surface of the semiconductor laser device, and the first cladding layer such that the second cladding layer covers the first core layer and the second core layer; and
optically coupling an optical fiber with a second end portion of the second core layer.

What is claimed is:

1. An optical waveguide device comprising:
a first silicon photonics chip having first and second surfaces on opposite sides and including a first silicon waveguide and a first electrode in a part closer to the second surface than to the first surface;
a second silicon photonics chip having third and fourth surfaces on opposite sides and including a second silicon waveguide and a second electrode in a part closer to the fourth surface than to the third surface;
an optical waveguide including
a core layer having a first end portion placed on the second surface of the first silicon photonics chip to be optically coupled with the first silicon waveguide and having a second end portion placed on the fourth surface of the second silicon photonics chip to be optically coupled with the second silicon waveguide;
a first cladding layer covering side surfaces of the first silicon photonics chip and the second silicon photonics chip, the first cladding layer covering a fifth surface of the core layer between the first end portion and the second end portion, the first cladding layer being thinner than the first silicon photonics chip and the second silicon photonics chip; and
a second cladding layer stacked on the first cladding layer and covering the second surface of the first silicon photonics chip and the fourth surface of the second silicon photonics chip and a side surface and a sixth surface of the core layer, the sixth surface being on an opposite side from the fifth surface; and
an encapsulation resin stacked on the first cladding layer on an opposite side from the second cladding layer and covering the first silicon photonics chip and the second silicon photonics chip.

2. The optical waveguide device as claimed in claim 1, further comprising:
a first through via piercing through the second cladding layer to have a first end face connected to the first electrode and a second end face exposed from the second cladding layer; and
a second through via piercing through the second cladding layer to have a first end face connected to the second electrode and a second end face exposed from the second cladding layer.

3. The optical waveguide device as claimed in claim 2, wherein
the first through via has a truncated cone shape narrowing toward the first electrode, the first through via being directly joined to the first electrode, and
the second through via has a truncated cone shape narrowing toward the second electrode, the second through via being directly joined to the second electrode.

4. The optical waveguide device as claimed in claim 2, wherein
the first through via has a pillar shape and is joined to the first electrode via a conductive joining material, and
the second through via has a pillar shape and is joined to the second electrode via the conductive joining material.

5. The optical waveguide device as claimed in claim 1, wherein an alignment mark is provided in the second surface of the first silicon photonics chip.

6. The optical waveguide device as claimed in claim 5, wherein the alignment mark is formed of a same material as the first silicon waveguide in a same layer as the first silicon waveguide.

7. The optical waveguide device as claimed in claim 1, wherein
the first silicon photonics chip includes a first substrate and a first insulating layer on the first substrate,
the first silicon waveguide and the first electrode are provided in the second surface of the first silicon photonics chip, the second surface being a surface of the first insulating layer facing away from the first substrate,
the second silicon photonics chip includes a second substrate and a second insulating layer on the second substrate, and
the second silicon waveguide and the second electrode are provided in the fourth surface of the second silicon photonics chip, the fourth surface being a surface of the second insulating layer facing away from the second substrate.

8. The optical waveguide device as claimed in claim 1, wherein
the first silicon photonics chip and the second silicon photonics chip are spaced apart from each other, and
the core layer lies over a gap between the first silicon photonics chip and the second silicon photonics chip, the gap being filled with the first cladding layer and the encapsulation resin.

9. A substrate with optical waveguides, comprising:
a wiring substrate including connection terminals; and
the optical waveguide device as set forth in claim 2, the optical waveguide device being mounted on the wiring substrate with the second cladding layer facing the connection terminals,
wherein the second end faces of the first through via and the second through via are joined to the connection terminals via a conductive joining material.

10. An optical waveguide device comprising:
a silicon photonics chip having first and second surfaces on opposite sides and including a first silicon waveguide, a second silicon waveguide, and a first electrode in a part closer to the second surface than to the first surface;
a semiconductor laser device having third and fourth surfaces on opposite sides and including a third silicon waveguide and a second electrode in a part closer to the fourth surface than to the third surface;
an optical waveguide including
a first core layer having a first end portion placed on the second surface of the silicon photonics chip to be optically coupled with the first silicon waveguide and having a second end portion placed on the fourth surface of the semiconductor laser device to be optically coupled with the third silicon waveguide;
a second core layer having an end portion placed on the second surface of the silicon photonics chip to be optically coupled with the second silicon waveguide;
a first cladding layer covering a side surface of the silicon photonics chip and a side surface of the semiconductor laser device, the first cladding layer covering a fifth surface of the first core layer between the first end portion and the second end portion and a sixth surface of the second core layer except the end portion, the first cladding layer being thinner than the silicon photonics chip and the semiconductor laser device;
a second cladding layer stacked on the first cladding layer and covering the second surface of the silicon photonics chip, the fourth surface of the semiconductor laser device, a side surface and a seventh surface of the first core layer, and a first side surface and an eighth surface of the second core layer, the seventh surface being on an opposite side from the fifth surface, the eighth surface being on an opposite side from the sixth surface;
an encapsulation resin stacked on the first cladding layer on an opposite side from the second cladding layer and covering the silicon photonics chip and the semiconductor laser device; and
an optical fiber placed next to the optical waveguide and the encapsulation resin,
wherein a second side surface of the second core layer is exposed from the first cladding layer and the second cladding layer and is optically coupled with the optical fiber, the second side surface being on an opposite side from the first side surface.

11. The optical waveguide device as claimed in claim 10, further comprising:
a first through via piercing through the second cladding layer to have a first end face connected to the first electrode and a second end face exposed from the second cladding layer; and
a second through via piercing through the second cladding layer to have a first end face connected to the second electrode and a second end face exposed from the second cladding layer.

12. The optical waveguide device as claimed in claim 11, wherein
the first through via has a truncated cone shape narrowing toward the first electrode, the first through via being directly joined to the first electrode, and
the second through via has a truncated cone shape narrowing toward the second electrode, the second through via being directly joined to the second electrode.

13. The optical waveguide device as claimed in claim 11, wherein
the first through via has a pillar shape and is joined to the first electrode via a conductive joining material, and
the second through via has a pillar shape and is joined to the second electrode via the conductive joining material.

14. The optical waveguide device as claimed in claim 10, wherein an alignment mark is provided in the second surface of the silicon photonics chip.

15. The optical waveguide device as claimed in claim 14, wherein the alignment mark is formed of a same material as the first silicon waveguide in a same layer as the first silicon waveguide.

16. The optical waveguide device as claimed in claim 10, wherein
the silicon photonics chip includes a first substrate and a first insulating layer on the first substrate,
the first silicon waveguide, the second silicon waveguide, and the first electrode are provided in the second surface of the silicon photonics chip, the second surface being a surface of the first insulating layer facing away from the first substrate,
the semiconductor laser device includes a second substrate and a second insulating layer on the second substrate, and
the third silicon waveguide and the second electrode are provided in the fourth surface of the semiconductor laser device, the fourth surface being a surface of the second insulating layer facing away from the second substrate.

17. The optical waveguide device as claimed in claim 10, wherein
the silicon photonics chip and the semiconductor laser device are spaced apart from each other, and
the first core layer lies over a gap between the silicon photonics chip and the semiconductor laser device, the gap being filled with the first cladding layer and the encapsulation resin.

18. A substrate with optical waveguides, comprising:
a wiring substrate including connection terminals; and
the optical waveguide device as set forth in claim 11, the optical waveguide device being mounted on the wiring substrate with the second cladding layer facing the connection terminals,
wherein the second end faces of the first through via and the second through via are joined to the connection terminals via a conductive joining material.
